(19) United States
(12) Patent Application Publication
(10) Pub. No.: US 2004/0044796 A1
(43) Pub. Date: Mar. 4, 2004

(54) Tracking out-of-order packets

(76) Inventors: Sriram R. Vangal, Portland, OR (US); Yatin Hoskote, Portland, OR (US); Nitin Y. Borkar, Beaverton, OR (US); Jianping Xu, Portland, OR (US); Vasantha K. Erranguntla, Beaverton, OR (US); Shekhar Y. Borkar, Beaverton, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/234,493

(22) Filed: Sep. 3, 2002

(51) Int. Cl. G06F 15/16

(52) U.S. Cl. 709/250

(57) ABSTRACT

In general, in one aspect, the disclosure describes a method for use in tracking received out-of-order packets. Such a method can include receiving at least a portion of a packet that includes data identifying an order within a sequence, and based on the data identifying the order, requesting stored data identifying a set of contiguous previously received out-of-order packets having an ordering within the sequence that borders the received packet.

This application relates to the following co-pending applications: “NETWORK PROTOCOL ENGINE”, attorney docket 42. P14732; and “PACKET-BASED CLOCK SIGNAL”, attorney docket 42.P14951. These applications were filed on the same day as the present application and name the same inventors.

### REFERENCE TO APPENDIX

This application includes an appendix, Appendix A, of micro-code instructions. The authors retain applicable copyright rights in this material.

### BACKGROUND

Networks enable computers and other electronic devices to exchange data such as e-mail messages, web pages, audio data, video data, and so forth. Before transmission across a network, data is typically distributed across a collection of packets. A receiver can reassemble the data back into its original form after receiving the packets.

In addition to the data (“payload”) being sent, a packet also includes “header” information. A network protocol can define the information stored in the header, the packet's structure, and how processes should handle the packet.

Different network protocols handle different aspects of network communication. Many network communication models organize these protocols into different layers. For example, models such as the Transmission Control Protocol/Internet Protocol (TCP/IP) model and the Open Software Institute (OSI) model define a “physical layer” that handles bit-level transmission over physical media; a “link layer” that handles the low-level details of providing reliable data communication over physical connections; a “network layer”, such as the Internet Protocol, that can handle tasks involved in finding a path through a network that connects a source and destination; and a “transport layer” that can coordinate communication between source and destination devices while insulating “application layer” programs from the complexity of network communication.

A different network communication model, the Asynchronous Transfer Mode (ATM) model, is used in ATM networks. The ATM model also defines a physical layer, but defines ATM and ATM Adaption Layer (AAL) layers in place of the network, transport, and application layers of the TCP/IP and OSI models.

Generally, to send data over the network, different headers are generated for the different communication layers. For example, in TCP/IP, a transport layer process generates a transport layer packet (sometimes referred to as a “segment”) by adding a transport layer header to a set of data provided by an application; a network layer process then generates a network layer packet (e.g., an IP packet) by adding a network layer header to the transport layer packet; a link layer process then generates a link layer packet (also known as a “frame”) by adding a link layer header to the network packet; and so on. This process is known as encapsulation. By analogy, the process of encapsulation is much like stuffing a series of envelopes inside one another.

After the packet(s) travel across the network, the receiver can de-encapsulate the packet(s) (e.g,. “unstuff” the envelopes). For example, the receiver's link layer process can verify the received frame and pass the enclosed network layer packet to the network layer process. The network layer process can use the network header to verify proper delivery of the packet and pass the enclosed transport segment to the transport layer process. Finally, the transport layer process can process the transport packet based on the transport header and pass the resulting data to an application.

As described above, both senders and receivers have quite a bit of processing to do to handle packets. Additionally, network connection speeds continue to increase rapidly. For example, network connections capable of carrying 10-gigabits per second and faster may soon become commonplace. This increase in network connection speeds imposes an important design issue for devices offering such connections. That is, at such speeds, a device may easily become overwhelmed with a deluge of network traffic.

### BRIEF DESCRIPTION OF THE DRAWINGS

FIGS. 1-5 illustrate operation of a scheme to track out-of-order packets.

FIG. 6 is a flowchart of a process to track out-of-order packets.

FIGS. 7-8 are schematics of a system to track out-of-order packets that includes content-addressable memory.

FIG. 9 is a block diagram of a network protocol engine.

FIG. 10 is a schematic of a network protocol engine.

FIG. 11 is a schematic of a processor of a network protocol engine.

FIG. 12 is a chart of an instruction set for programming network protocol operations.

FIG. 13 is a diagram of a TCP (Transmission Control Protocol) state machine.

FIG. 14 is a diagram of a network protocol engine featuring different clock frequencies.

FIG. 15 is a diagram of a network protocol engine featuring different variable clock frequencies.

FIG. 16 is a diagram of a mechanism for providing a clock signal based on packet characteristics.

### DETAILED DESCRIPTION

As described above, data is often divided into individual packets before transmission across a network. Oftentimes, the individual packets take very different paths across a network before reaching their destination. For this and other reasons, many network protocols do not assume that packets will arrive in the correct order. Thus, many systems buffer out-of-order packets until the in-order packets arrive.

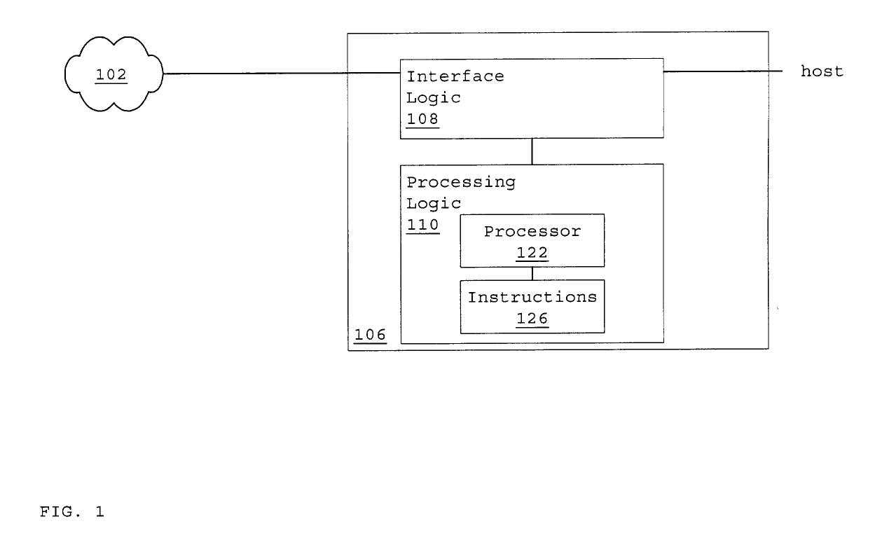

FIGS. 1-5 illustrate operation of a scheme that tracks packets received out-of-order. The scheme permits quick “on-the-fly” ordering of packets without employing a traditional sorting algorithm. The implementation shown uses content-addressable memory (CAM) to track out-of-order packets. A CAM can quickly retrieve stored data based on content values much in the way a database can retrieve records based on a key. However, other implementations may use addressed-based memory other data storage techniques.

Briefly, when a packet arrives, the system 100 determines whether the received packet is in-order. If not, the system 100 consults the memory 110, 112 to identify a chain of contiguous out-of-order packets previously received by the system 100 that border the newly arrived packet. If a bordering chain is found, the system 100 can modify the data stored in the memory 110, 112 to add the packet to the top or bottom of a preexisting chain of out-of-order packets. When an in-order packet finally arrives, the system 100 can access the memory 110, 112 to quickly identify a chain of contiguous packets that follow the in-order packet.

For the purposes of illustration, FIGS. 1-5 describe a scheme that tracks TCP packets. However, the approach shown has applicability to a wide variety of packets such as numbered packets (e.g., protocol data unit fragments) and so forth. Thus, while the description below discusses storage of TCP sequence numbers, an embodiment for numbered packets can instead store the packet numbers (e.g., a chain will start with the first packet number instead of the first sequence number).

Briefly, TCP (Transmission Control Protocol) uses a scheme where each individual byte is assigned a sequence number. A TCP packet (or “segment”) header will include identification of the starting sequence number of the packet. Thus, a receiver can keep track of the next sequence number expected and await a packet including this sequence number. Out-of-order packets featuring sequence numbers other than the expected sequence number may be stored until the intervening sequence numbers arrive

As shown in FIG. 1, a protocol 104 (e.g., TCP) divides a set of data 102 into a collection of packets 106a-106d for transmission over a network 108. In the example shown, the 15-bytes of the original data 102 are distributed across the packets 106a-106d. For example, packet 106d includes bytes assigned sequence numbers “1” to “3”.

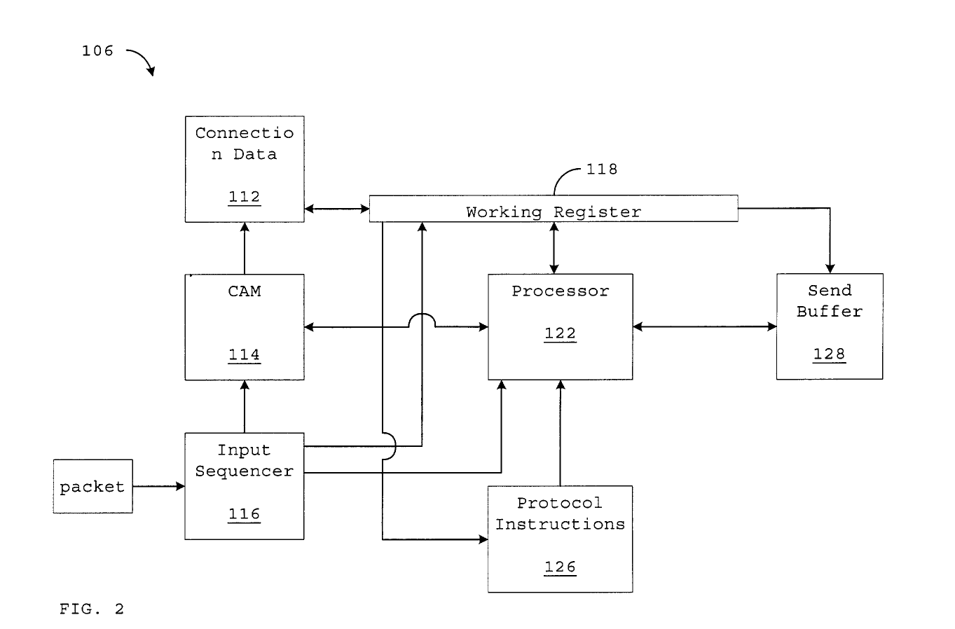

As shown, a device 100 includes content-addressable memory 110, 112 that stores information about received, out-of-order packets. In this implementation, the content-addressable memory 110 stores the first sequence number of a contiguous chain of one or more out-of-order packets and the length of the chain. Thus, when a new packet arrives that ends where the pre-existing chain begins (e.g., the first sequence number of the chain follows the last sequence number of the packet), the packet can be added to the top of the pre-existing chain. Similarly, the content-addressable memory 112 also stores the end (the last sequence number+1) of a contiguous packet and the length of the chain. Thus, when a new packet arrives that begins at the end of a previously existing chain (e.g., the first sequence number of the new packet follows the last sequence number of the chain), the new packet can be appended to the end of the previously existing chain to form an even larger chain of contiguous packets. To illustrate these operations, FIGS. 2-5 depict a sample series of operations that occur as the packets 106a-106d arrive.

As shown in FIG. 2, packet 106b arrives carrying bytes with sequence numbers “8” through “12”. Assuming the device 100 currently awaits sequence number “1”, packet 106b has arrived out-of-order. Thus, as shown, the device 100 tracks the out-of-order packet 106b by modifying data stored in its content-addressable memory 110, 112. The packet 106b does not border a previously received packet chain as no chain yet exists in this example. Thus, the device 100 stores the starting sequence number “8” and the number of bytes in the packet “4”. The device 100 also stores identification of the end of the packet. In the example shown, the device 100 stores the ending boundary by adding one to the last sequence number of the received packet (e.g., 12+1=13). In addition to modifying or adding entries in the content-addressable memory 110, 112, the device 100 can store the packet or a reference (e.g., a pointer) to the packet 111b to reflect the relative order of the packet. This permits fast retrieval of the packets when finally sent to an application.

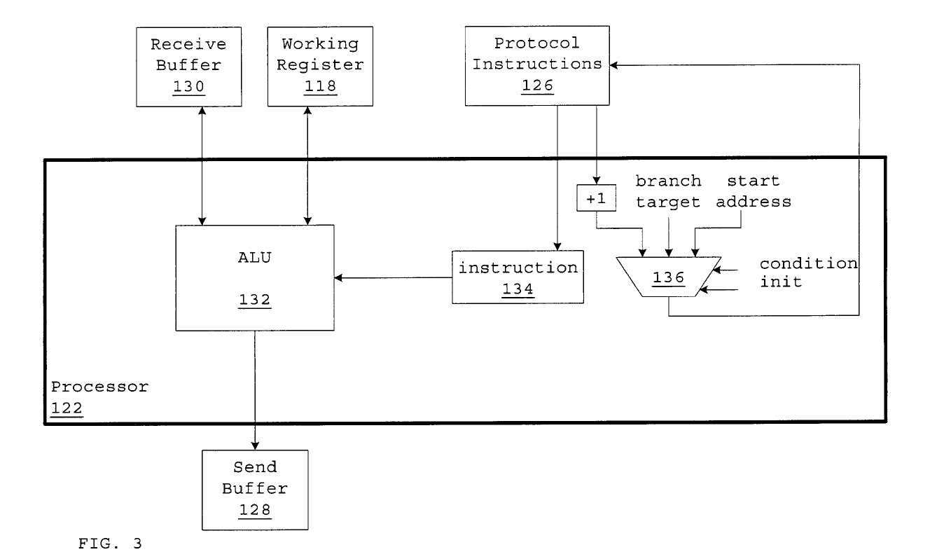

As shown in FIG. 3, the device 100 next receives packet 106a carrying bytes “13” through “15”. Again, the device 100 still awaits sequence number “1”. Thus, packet 106a has also arrived out-of-order. The device 100 examines memory 110, 112 to determine whether the received packet 106a borders any previously stored packet chains. In this case, the newly arrived packet 106a does not end where a previous chain begins, but does begin where a previous chain ends. In other words, the packet 106a borders the “bottom” of packet 106b. As shown, the device 100 can merge the packet 106a into the pre-existing chain in the content-addressable memory data by increasing the length of the chain and modifying its first and last sequence number data accordingly. Thus, the first sequence number of the new chain remains “8” though the length is increased from “4” to “7”, while the end sequence number of the chain is increased from “13” to “16” to reflect the bytes of the newly received packet 106a. The device 100 also stores the new packet 111a or a reference to the new packet to reflect the relative ordering of the packet.

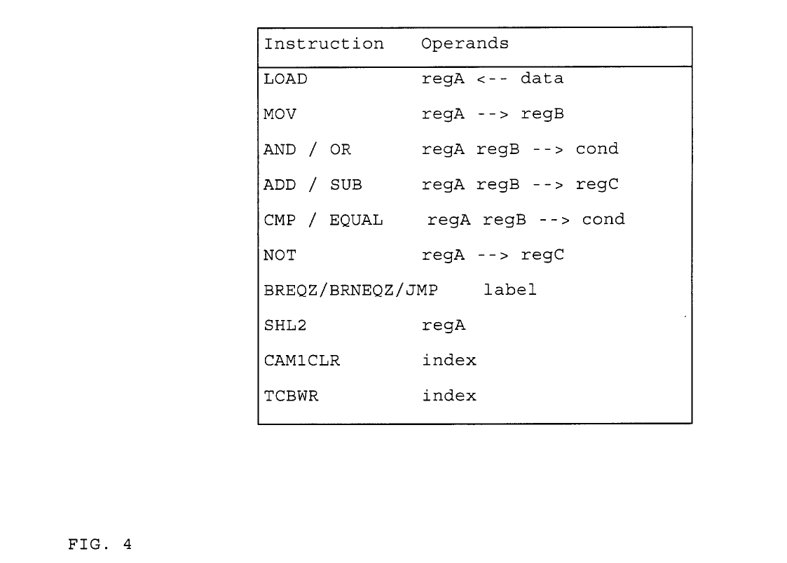

As shown in FIG. 4, the device 100 next receives packet 106c carrying bytes “4” to “7”. Since this packet 106c does not include the next expected sequence number, “1”, the device 100 repeats the process outlined above. That is, the device 100 determines that the newly received packet 106c fits “atop” the packet chain spanning packets 106b, 106a. Thus, the device 100 modifies the data stored in the content-addressable memory 110, 112 to include a new starting sequence number for the chain, “4”, and a new length data for the chain, “11”. The device 100 again stores the packet 111c data or a reference to the data to reflect the packet's relative ordering within the sequence.

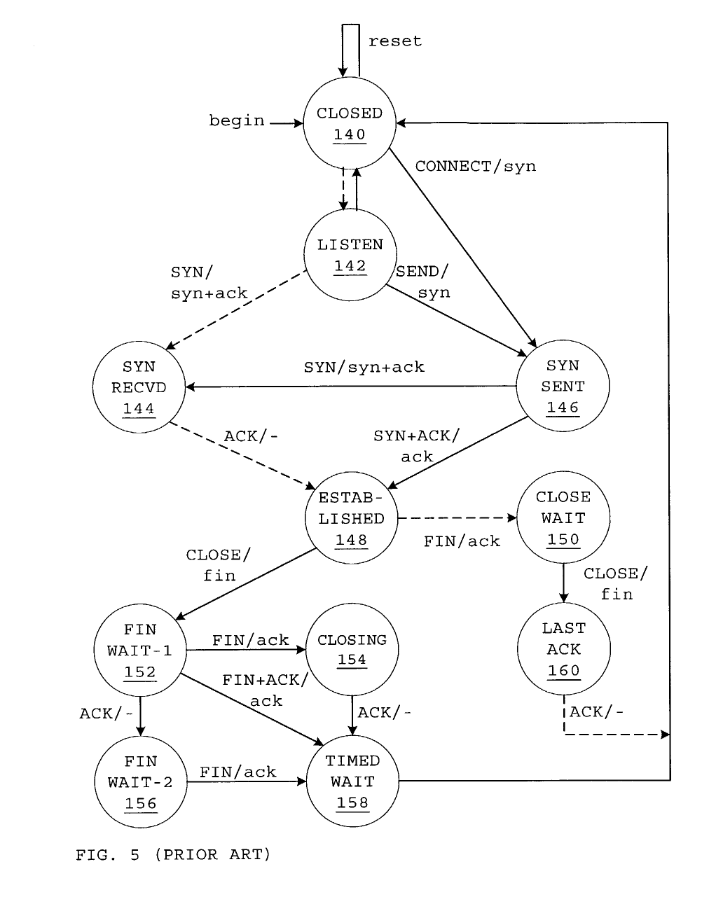

As shown in FIG. 5, the device 100 finally receives packet 106d that includes the next expected sequence number, “1”. The device 100 can immediately transfer this packet 106d to an application. The device 100 can also examine its content-addressable memory 110 to see if other packet chains can also be sent to the application. In this case, the received packet 106d borders a packet chain that already spans packets 106a-106c. Thus, the device 100 can immediately forward the data of the chained packets 106a-106c to the application in the correct order.

The sample series shown in FIGS. 1-5 highlights several aspects of the scheme. First, the scheme may prevent out-of-order packets from being dropped and being retransmitted by the sender. This can improve overall throughput. The scheme also uses very few content-addressable memory operations 110, 112 to handle out-of-order packets, saving both time and power. Further, when a packet arrives in the correct order, a single content-addressable memory operation can identify a series of contiguous packets that can also be sent to the application.

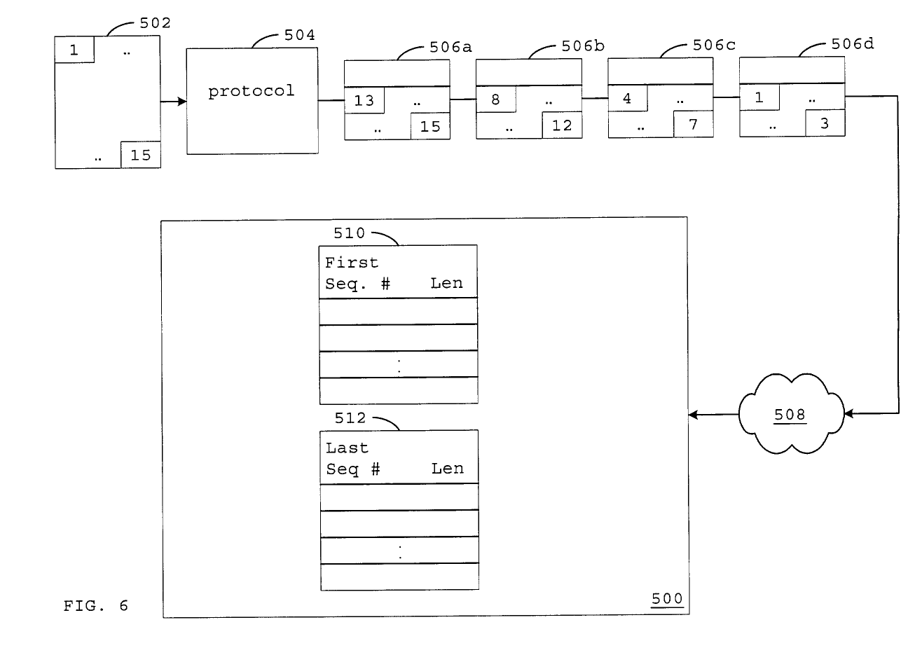

FIG. 6 depicts a flowchart of a process 120 for implementing the scheme illustrated above. As shown, after receiving 122 a packet, the process 120 determines 124 whether the packet is in order (e.g., whether the packet includes the next expected sequence number). If not, the process 120 determines 132 whether the end of the received packet borders the start of an existing packet chain. If so, the process 120 can modify 134 the data stored in content-addressable memory to reflect the larger, merged packet chain starting at the received packet and ending at the end of the previously existing packet chain. The process 120 also determines 136 whether the start of the received packet borders the end of an existing packet chain. If so, the process 120 can modify 138 the data stored in content-addressable memory to reflect the larger, merged packet chain ending with the received packet.

Potentially, the received packet may border pre-existing packet chains on both sides. In other words, the newly received packet fills a hole between two chains. Since the process 120 checks both starting 132 and ending 136 borders of the received packet, a newly received packet may cause the process 120 to join two different chains together into a single monolithic chain.

As shown, if the received packet does not border a packet chain, the process 120 stores 140 data in content-addressable memory for a new packet chain that, at least initially, includes only the received packet.

If the received packet is in order, the process 120 can query 126 the content-addressable memory to identify a bordering packet chain following the received packet. If such a chain exists, the process 120 can output the newly received packet to an application along with the data of other packets in the adjoining packet chain.

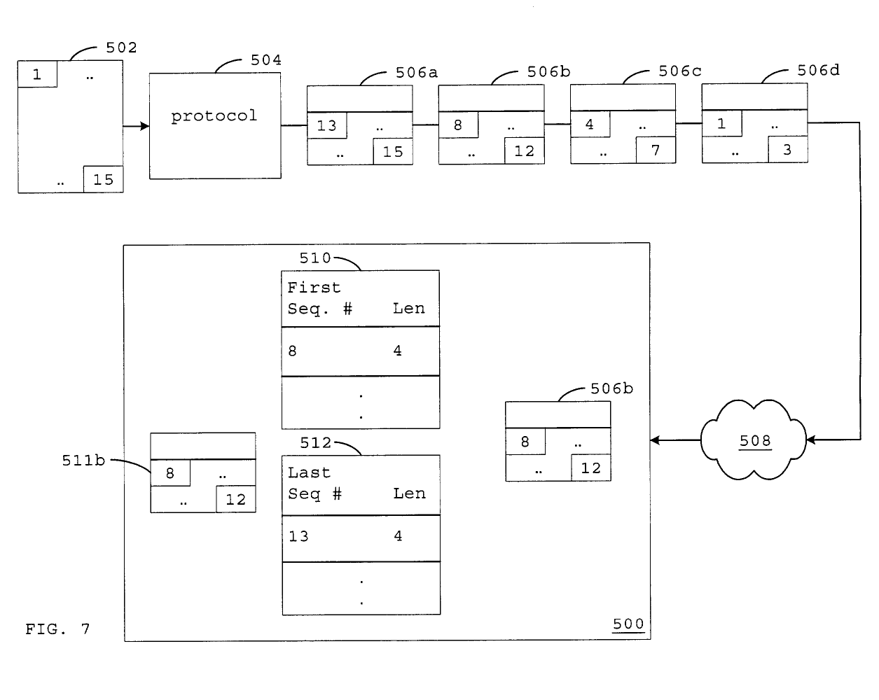

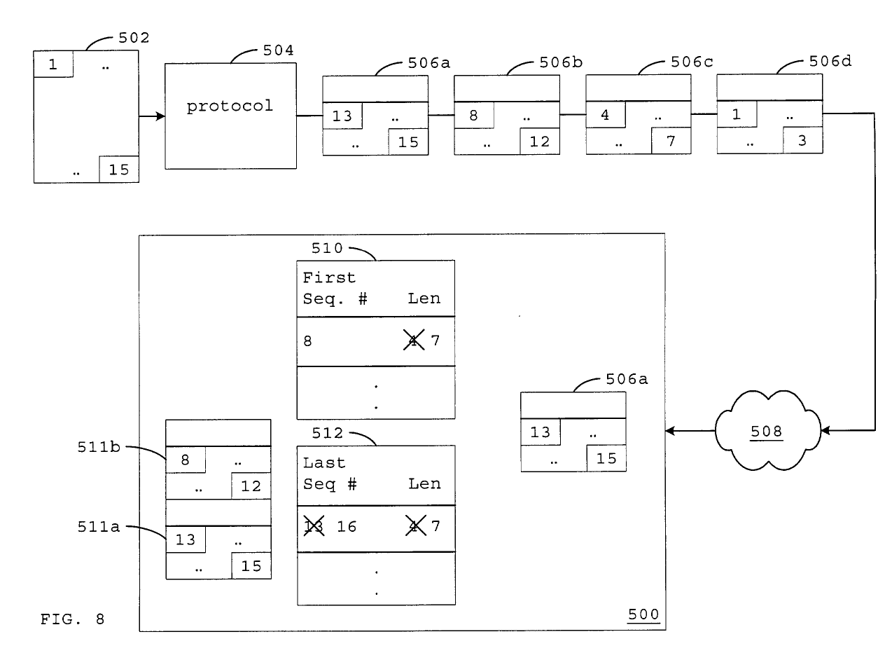

This process 120 may be implemented using a wide variety of hardware, firmware, and/or software. For example, FIGS. 7 and 8 depict a hardware implementation of the scheme described above. As shown in these figures, the implementation features two content-addressable memories 160, 162—one 160 stores the first sequence number of an out-of-order packet chain as the key and the other 162 stores the last+1 sequence number of the chain as the key. As shown, both CAMs 160, 162 also store the length of the chains. Other implementations may use a single CAM or other data storage mechanism.

Potentially, the same CAM(s) 160, 162 can be used to track packets of many different connections. In such cases, a connection ID may be appended to each CAM entry as part of the key to distinguish entries for different connections. The merging of packet information in the CAM permits the handling of more connections with smaller CAMs.

As shown in FIG. 7, the implementation includes registers that store a starting sequence number 150, ending sequence number 152, and a data length 154. Another system can access registers 150, 152, 154 to communicate with the packet re-ordering components.

As shown, the implementation operates on control signals for reading from the CAM(s) 160, 162 (CAMREAD), writing to the CAMs 160, 162 (CAMWRITE), and clearing a CAM 160, 162 entry (CAMCLR). As shown in FIG. 7, the hardware may be configured to simultaneously write register values to both CAMs 160, 162 when the registers 150, 152, 154 are loaded with data. As shown in FIG. 8, for “hits” for a given start or end sequence number, the circuitry sets the “seglen” register to the length of a matching CAM entry. Similar, circuitry (not shown) may also set the values of the “seqfirst” 150 and “seqlast” 152 registers after a successful CAM 160, 162 read operation. The circuitry may also provide a “CamIndex” signal that identifies a particular “hit” entry in the CAM(s) 160, 162.

The re-ordering system 100 may feature additional circuitry (not shown) for implementing the process described above. For example, the system 100 may feature its own independent controller that executes instructions implementing the reordering scheme or other digital logic. Alternately, the system 100 may receive control signals from an external processor.

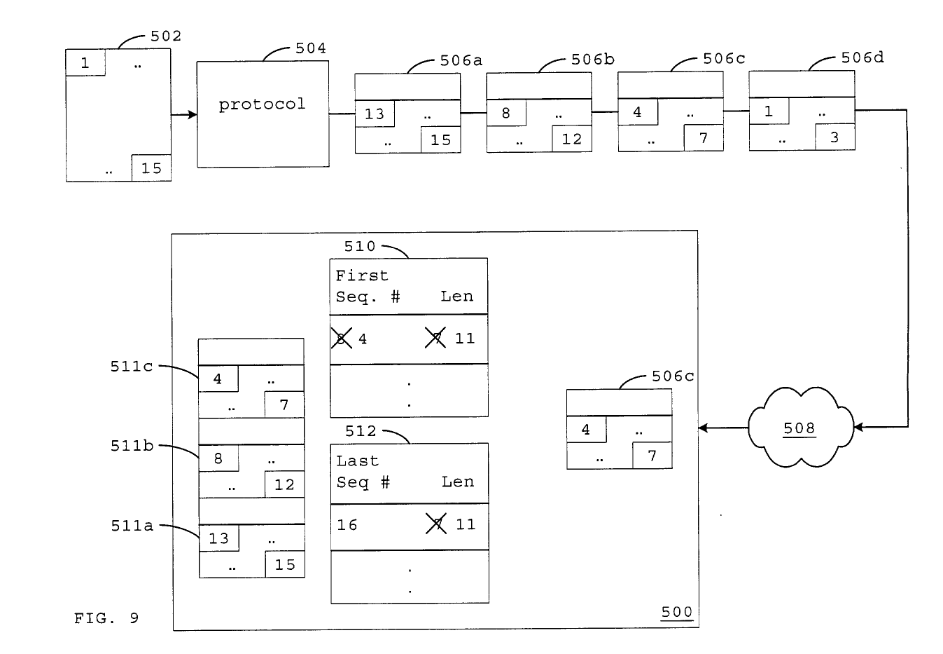

The tracking system described above may be used by a wide variety of systems. For example, referring to FIG. 9, the system may be used by or integrated into a network protocol off-load engine 206. Briefly, much in the way a math co-processor can help a Central Processing Unit (CPU) with different computations, an off-load engine 206 can at least partially reduce the burden of network communication often place on a host by performing different network protocol operations. For example, an engine 206 can be configured to perform operations for transport layer protocols (e.g., TCP and User Datagram Protocol (UDP)), network layer protocols (e.g., IP), and application layer protocols (e.g., sockets programming). Similarly, in ATM networks, an engine 206 can be configured to provide ATM layer or AAL layer operations. an engine 206 can also be configured to provide other protocol operations such as those associated with ICMP.

In addition to conserving host processor resources by handling protocol operations, the engine 206 may provide “wire-speed” processing, even for very fast connections including 10-gigabit per second connections and 40-gigabit per second connections. In other words, the system 206 may, generally, complete processing of one packet before another arrives. By keeping pace with a high-speed connection, the engine 206 can potentially avoid or reduce the cost and complexity associated with queuing large volumes of backlogged packets.

The sample system 206 shown includes an interface 208 for receiving data traveling between one or more hosts and a network 202. For out-going data, the system 206 interface 208 receives data from the host(s) and generates packets for network transmission, for example, via a PHY and medium access control (MAC) device (not shown) offering a network connection (e.g., an Ethernet or wireless connection). For received packets (e.g., received via the PHY and MAC), the system 206 interface 208 can deliver the results of packet processing to the host(s). For example, the system 206 may communicate with a host via a Small Computer System Interface (SCSI) or Peripheral Component Interconnect (PCI) type bus (e.g., a PCI-X bus system).

In addition to the interface 208, the engine 206 also includes processing logic 210 that implements protocol operations. Like the interface 208, the logic 210 may be designed using a wide variety of techniques. For example, the engine 206 may be designed as a hard-wired ASIC (Application Specific Integrated Circuit), a FPGA (Field Programmable Gate Array), and/or as another combination of digital logic gates.

As shown, the digital logic 210 may also be implemented by a processor 222 (e.g., a micro-controller or micro-processor) and storage 226 (e.g., ROM (Read-Only Memory) or RAM (Random Access Memory)) for instructions that the processor 222 can execute to perform network protocol operations. The instruction-based engine 206 offers a high degree of flexibility. For example, as a network protocol undergoes changes or is replaced, the engine 206 can be updated by replacing the instructions instead of replacing the system 206 itself. For example, a host may update the system 206 by loading instructions into storage 226 from external FLASH memory or ROM on the motherboard, for instance, when the host boots.

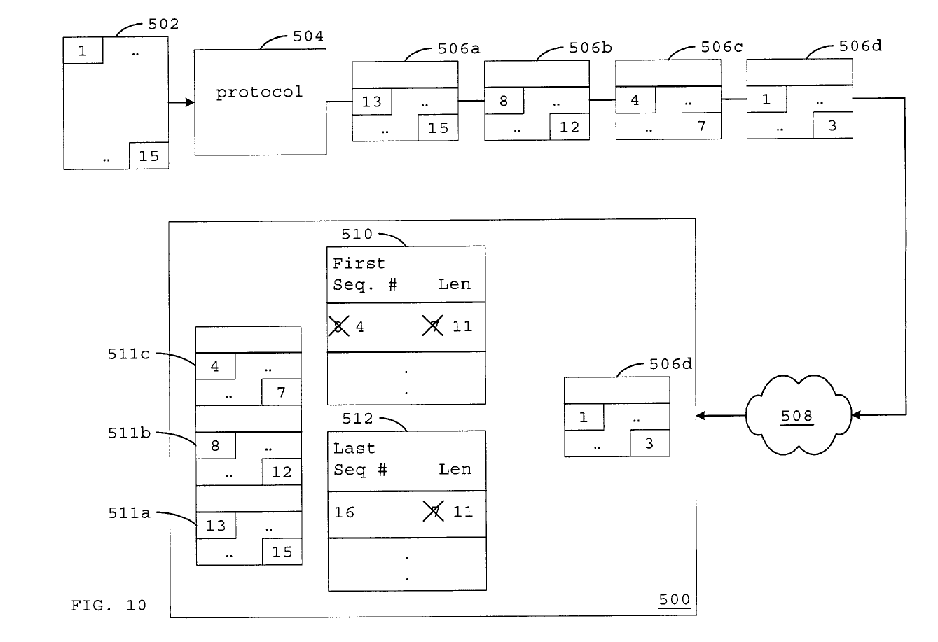

FIG. 10 depicts a sample implementation of a system 206. As an overview, in this implementation, the system 206 stores context data for different connections in a memory 212. For example, for the TCP protocol, this data is known as TCB (Transmission Control Block) data. For a given packet, the system 206 looks-up the corresponding context 212 and makes this data available to the processor 222, in this example, via a working register 218. Using the context data, the processor 222 executes an appropriate set of protocol implementation instructions 226. Context data, potentially modified by the processor 222, is then returned to the context data memory 212.

In greater detail, the system 206 shown includes an input sequencer 216 that parses a received packet's header(s) (e.g., the TCP and IP headers of a TCP/IP packet) and temporarily buffers the parsed data. The input sequencer 216 may also initiate storage of the packet's payload in host accessible memory (e.g., via DMA (Direct Memory Access)).

As described above, the system 206 stores context data 212 of different network connections. To quickly retrieve context data 212 for a given packet, the system 206 depicted includes a content-addressable memory 214 (CAM) that stores different connection identifiers (e.g., index numbers) for different connections as identified, for example, by a combination of a packet's IP source and destination addresses and source and destination ports. Thus, based on the packet data parsed by the input sequencer 216, the CAM 214 can quickly retrieve a connection identifier and feed this identifier to the context data 212 memory. In turn, the connection data 212 corresponding to the identifier is transferred to the working register 218 for use by the processor 222.

In the case that a packet represents the start of a new connection (e.g., a CAM 214 search for a connection fails), the working register 218 is initialized (e.g., set to the “LISTEN” state in TCP) and CAM 214 and a context data 212 entries are allocated for the connection, for example, using a LRU (Least Recently Used) algorithm or other allocation scheme.

The number of data lines connecting different components of the system 206 may be chosen to permit data transfer between connected components 212-228 in a single clock cycle. For example, if the context data for a connection includes n-bits of data, the system 206 may be designed such that the connection data memory 212 may offer n-lines of data to the working register 218.

Thus, the sample implementation shown uses at most three processing cycles to load the working register 218 with connection data: one cycle to query the CAM 214; one cycle to access the connection data 212; and one cycle to load the working register 218. This design can both conserve processing time and economize on power-consuming access to the memory structures 212, 214.

After retrieval of connection data for a packet, the system 206 can perform protocol operations for the packet, for example, by processor 222 execution of protocol implementation instructions stored in memory 226. The processor 222 may be programmed to “idle” when not in use to conserve power. After receiving a “wake” signal (e.g., issued by the input sequencer 216 when the connection context is retrieved or being retrieved), the processor 222 may determine the state of the current connection and identify the starting address of instructions for handling this state. The processor 222 then executes the instructions beginning at the starting address. Depending on the instructions, the processor 222 can alter context data (e.g., by altering working register 218), assemble a message in a send buffer 228 for subsequent network transmission, and/or may make processed packet data available to the host (not shown).

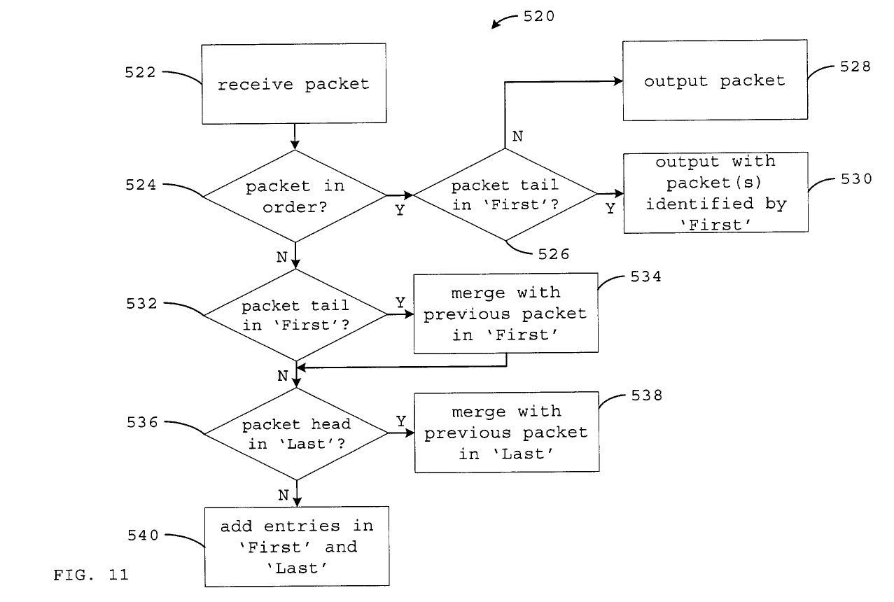

FIG. 11 depicts the processor 222 in greater detail. As shown, the processor 222 may include an ALU (arithmetic logic unit) 232 that decodes and executes micro-code instructions loaded into an instruction register 234. The instructions 226 may be loaded 236 into the instruction register 234 from memory 226 in sequential succession with exceptions for branching instructions and start address initialization. The instructions may specify access (e.g., read or write access) to a receive buffer 230 that stores the parsed packet data, the working register 218, the send buffer 228, and/or host memory (not shown). The instructions may also specify access to scratch memory, miscellaneous registers (e.g., registers dubbed RO, cond, and statusok), shift registers, and so forth (not shown). For programming convenience, the different fields of the send buffer 228 and working register 226 may be assigned labels for use in the instructions. Additionally, various constants may be defined, for example, for different connection states. For example, “LOAD TCB[state], LISTEN” instructs the processor 222 to change the state of the context state stored in the working register 218 to the “LISTEN” state.

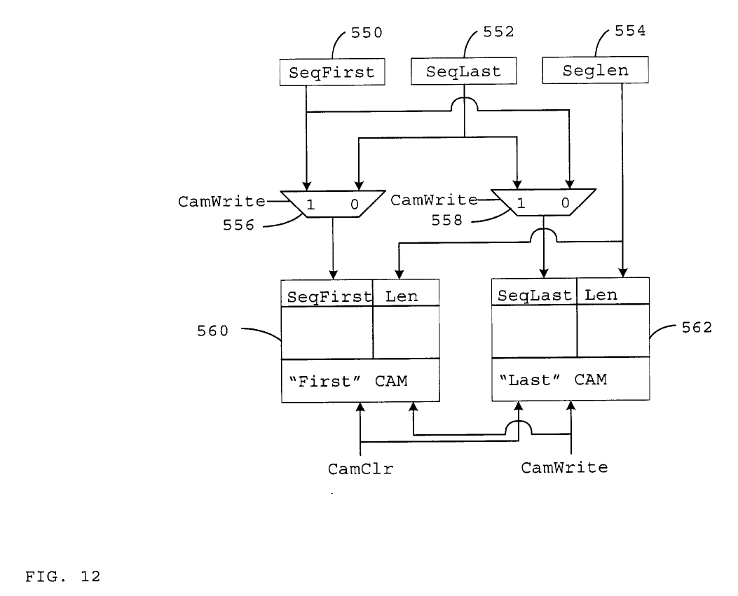

FIG. 12 depicts an example of a micro-code instruction set that can be used to program the processor to perform protocol operations. As shown, the instruction set includes operations that move data within the system (e.g., LOAD and MOV), perform mathematic and Boolean operations (e.g., AND, OR, NOT, ADD, SUB), compare data (e.g., CMP and EQUAL), manipulate data (e.g., SHL (shift left)), and provide branching within a program (e.g., BREQZ (conditionally branch if the result of previous operation equals zero), BRNEQZ (conditionally branch if result of previous operation does not equal zero), and JMP (unconditionally jump)).

The instruction set also includes operations specifically tailored for use in implementing protocol operations with system 206 resources. These instructions include operations for clearing the context CAM 214 of an entry for a connection (e.g., CAM1CLR) saving context data (e.g., TCBWR). Other implementations may also include instructions that read and write identifier information to the CAM storing data associated with a connection (e.g., CAM1READ key→index) and CAM1WRITE key→index) and an instruction that reads the connection data 112 (e.g., TCBRD index→destination). Alternately, these instructions may be implemented as hard-wired digital logic.

The instruction set may also include instructions for operating the out-of-order tracking system 100. For example, Such instructions may include instructions to write data to the system 100 CAM(s) 160, 162 (e.g., CAM2FirstWR key→data for CAM 160 and CAM2LastWR key→data for CAM 162); instructions to read data from the CAM(s) (e.g., CAM2FirstRD key→data and CAM2LastRD key→data); instructions to clear CAM 160, 162 entries (e.g., CAM2CLR index), and/or instructions to generate a condition value if a lookup failed (e.g., CAM2EMPTY→cond).

Though potentially lacking many instructions offered by traditional general purpose CPUs (e.g., processor 222 may not feature floating-point operations), the instruction set provides developers with easy access to system 206 resources tailored for network protocol implementation. A programmer may directly program protocol operations using the micro-code instructions. Alternately, the programmer may use a wide variety of code development tools (e.g., a compiler or assembler).

As described above, the system 206 instructions implement operations for a wide variety of network protocols. For example, the system 206 may implement operations for a transport layer protocol such as TCP. A complete specification of TCP and optional extensions can be found in RFCs (Request for Comments) 793, 1122, and 1323.

Briefly, TCP provides connection-oriented services to applications. That is, much like picking up a telephone and assuming the phone company will make everything work, TCP provides applications with simple primitives for establishing a connection (e.g., CONNECT and CLOSE) and transferring data (e.g., SEND and RECEIVE). TCP transparently handles communication issues such as data retransmission, congestion, and flow control.

As described above, TCP operates on packets known as segments. A TCP segment includes a TCP header followed by one or more data bytes. A receiver can reassemble the data from received segments. Segments may not arrive at their destination in their proper order, if at all. For example, different segments may travel very paths across the network, Thus, TCP assigns a sequence number to each data byte transmitted. Since every byte is sequenced, each byte can be acknowledged to confirm successful transmission. The acknowledgment mechanism is cumulative so that an acknowledgment of a particular sequence number indicates that bytes up to that sequence number have been successfully delivered.

The sequencing scheme provides TCP with a powerful tool for managing connections. For example, TCP can determine when a sender should retransmit a segment using a technique known as a “sliding window”. In the “sliding window” scheme, a sender starts a timer after transmitting a segment. Upon receipt, the receiver sends back an acknowledgment segment having an acknowledgement number equal to the next sequence number the receiver expects to receive. If the sender's timer expires before the acknowledgment of the transmitted bytes arrives, the sender transmits the segment again. The sequencing scheme also enables senders and receivers to dynamically negotiate a window size that regulates the amount of data sent to the receiver based on network performance and the capabilities of the sender and receiver.

In addition to sequencing information, a TCP header includes a collection of flags that enable a sender and receiver to control a connection. These flags include a SYN (synchronize) bit, an ACK (acknowledgement) bit, a FIN (finish) bit, a RST (reset) bit. A message including a SYN bit of “1” and an ACK bit of “0” (a SYN message) represents a request for a connection. A reply message including a SYN bit “1” and an ACK bit of “1” (a SYN+ACK message) represents acceptance of the request. A message including a FIN bit of “1” indicates that the sender seeks to release the connection. Finally, a message with a RST bit of “1” identifies a connection that should be terminated due to problems (e.g., an invalid segment or connection request rejection).

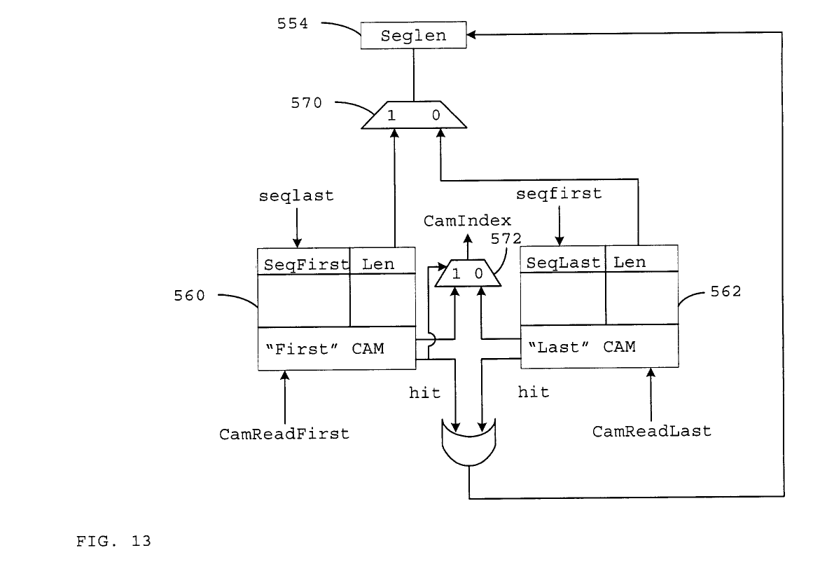

FIG. 13 depicts a state diagram representing different stages in the establishment and release of a TCP connection. The diagram depicts different states 240-260 and transitions (depicted as arrowed lines) between the states 240-260. The transitions are labeled with corresponding event/action designations that identify an event and response required to move to a subsequent state 240-260. For example, after receiving a SYN message and responding with a SYN+ACK message, a connection moves from the LISTEN state 242 to the SYN RCVD state 244.

In the state diagram of FIG. 13, the typical path for a sender (a TCP entity requesting a connection) is shown with solid transitions while the typical paths for a receiver is shown with dotted line transitions. To illustrate operation of the state machine, a receiver typically begins in the CLOSED state 240 that indicates no connection is currently active or pending. After moving to the LISTEN 242 state to await a connection request, the receiver will receive a SYN message requesting a connection and will acknowledge the SYN message with a SYN+ACK message and enter the SYN RCVD state 244. After receiving acknowledgement of the SYN+ACK message, the connection enters an ESTABLISHED state 248 that corresponds to normal on-going data transfer. The ESTABLISHED state 148 may continue for some time. Eventually, assuming no reset message arrives and no errors occur, the server will receive and acknowledge a FIN message and enter the CLOSE WAIT state 250. After issuing its own FIN and entering the LAST 25 ACK state 260, the server will receive acknowledgment of its FIN and finally return to the original CLOSED 240 state.

Again, the state diagram also manages the state of a TCP sender. The sender and receiver paths share many of the same states described above. However, the sender may also enter a SYN SENT state 246 after requesting a connection, a FIN WAIT 1 state 252 after requesting release of a connection, a FIN WAIT 2 state 256 after receiving an agreement from the server to release a connection, a CLOSING state 254 where both client and server request release simultaneously, and a TIMED WAIT state 258 where previously transmitted connection segments expire.

The engine's 206 protocol instructions may implement many, if not all, of the TCP operations described above and in the RFCs. For example, the instructions may include procedures for option processing, window management, flow control, congestion control, ACK message generation and validation, data segmentation, special flag processing (e.g., setting and reading URGENT and PUSH flags), checksum computation, and so forth. The protocol instructions may also include other operations related to TCP such as security support, random number generation, RDMA (Remote Direct Memory Access) over TCP, and so forth.

In an engine 206 configured to provide TCP operations, the connection data may include 264-bits of information including: 32-bits each for PUSH (identified by the micro-code label “TCB[pushseq]”), FIN (“TCB[finseq]”), and URGENT (“TCB[rupseq]”) sequence numbers, a next expected segment number (“TCB[rnext]”), a sequence number for the currently advertised window (“TCB[cwin]”), a sequence number of the last unacknowledged sequence number (“TCB[suna]”), and a sequence number for the next segment to be next (“TCB[snext]”). The remaining bits store various TCB state flags (“TCB[flags]”), TCP segment code (“TCB[code]”), state (“TCB[tcbstate]”), and error flags (“TCB[error]”),

To illustrate programming for a TCP configured off-load engine 206, Appendix A features an example of source micro-code for a TCP receiver. Briefly, the routine TCPRST checks the TCP ACK bit, initializes the send buffer, and initializes the send message ACK number. The routine TCPACKIN processes incoming ACK messages and checks if the ACK is invalid or a duplicate. TCPACKOUT generates ACK messages in response to an incoming message based on received and expected sequence numbers. TCPSEQ determines the first and last sequence number of incoming data, computes the size of incoming data, and checks if the incoming sequence number is valid and lies within a receiving window. TCPINITCB initializes TCB fields in the working register. TCPINITWIN initializes the working register with window information. TCPSENDWIN computes the window length for inclusion in a send message. Finally, TCBDATAPROC checks incoming flags, processes “urgent”, “push” and “finish” flags, sets flags in response messages, and forwards data to an application or user

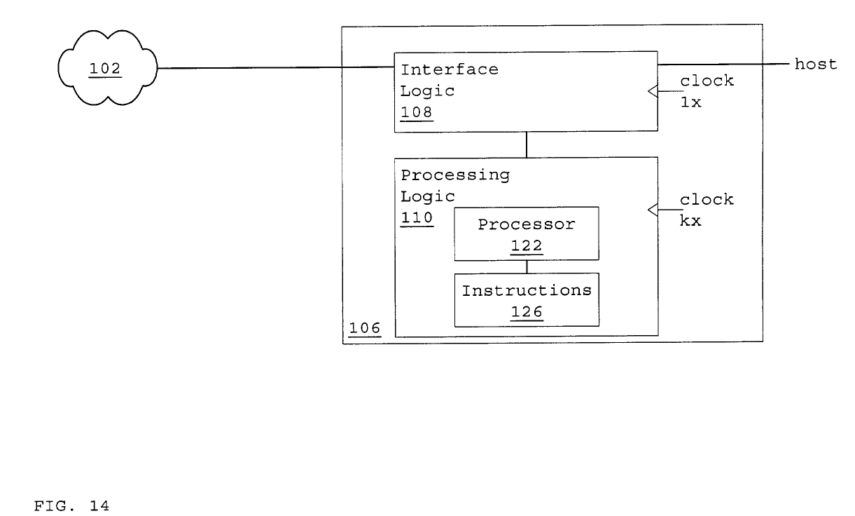

Referring to FIG. 14, potentially, components of the interface 208 and processing 210 logic components may be clocked at the same frequency. A clock signal essentially determines how fast components in a logic network will operate. Unfortunately, due to the fact that many instructions may be executed for a given packet, to operate at wire-speed, the engine 206 might be clocked at a very fast rate far exceeding the rate needed to keep pace with the connection. Running the entire engine 206 at a single very fast clock can both consume a tremendous amount of power and generate high temperatures that may affect the behavior of heat-sensitive silicon.

Instead, as shown in FIG. 14, components in the interface 208 and processing 210 logic may be clocked at different rates. As an example, the interface 208 components may be clocked at a rate, “1×”, corresponding to the speed of the network connection. Since the processing logic 210 may be programmed to execute a number of instructions to perform appropriate network protocol operations for a given packet, the processing logic 210 components, including the ordering system 100, may be clocked at a faster rate than the interface 208. For example, the processing logic 210 may be clocked at some multiple “k” of the interface 208 clock frequency where “k” is sufficiently high to provide enough time for the processor to finish executing instructions for the packet without falling behind wire speed. Systems 106 using the “multiple-clock” approach may feature devices known as “synchronizers” (not shown) that permit differently clocked components to communicate.

As an example, for an engine 206 having an interface 208 data width of 16-bits, to achieve 10-gigabits per second, the interface 208 should be clocked at a frequency of 625-MHz (e.g., [16-bits per cycle]×[625,000,000 cycles per second]=10,000,000,000 bits per second). Assuming a smallest packet of 64 bytes (e.g., a packet only having IP and TCP headers, frame check sequence, and hardware source and destination addresses), it would take the 16-bit/625 MHz interface 108 32-cycles to receive the packet bits. Potentially, an inter-packet gap may provide additional time before the next packet arrives. If a set of up to n instructions is used to process the packet and a different instruction can be executed each cycle, the processing block 110 may be clocked at a frequency of k·(625 MHz) where k=n-instructions/32-cycles. For implementation convenience, the value of k may be rounded up to an integer value or a value of 2ⁿ though neither of these is a strict requirement.

Since a faster clock generally requires greater power and generates more heat than a slower clock, clocking the different components 208, 210 at different speeds according to their need can enable the engine 206 to save power and stay cooler. This can both reduce the power requirements of the engine 206 and can reduce the need for expensive cooling systems.

Power consumption and heat generation can be reduced even further than the system shown in FIG. 14. That is, the engine 206 depicted in FIG. 14 featured system 206 logic components clocked at different, fixed rates determined by “worst-case” scenarios to ensure that the processing block 210 keeps pace with wire-speed. As such, the smallest packets constrained processing logic 210 clock speed. In practice, however, most packets, nearly 95%, feature larger packet sizes and afford the system 106 more time for processing.

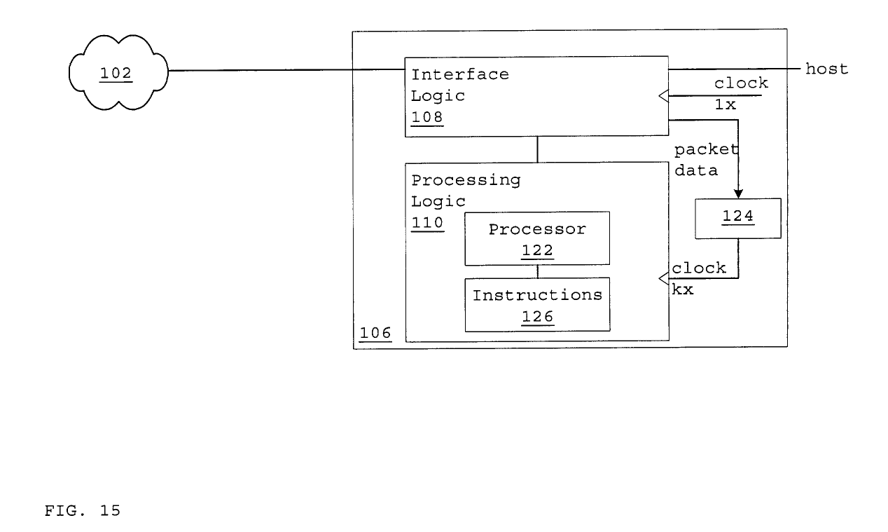

Thus, instead of permanently tailoring the engine 206 to handle difficult scenarios, FIG. 15 depicts a system 206 that provides a clock signal to processing logic 210 components at frequencies that dynamically vary based on one or more packet characteristics. For example, a system 206 may use data identifying a packet's size (e.g., the length field in the IP datagram header) to scale the clock frequency. For instance, for a bigger packet, the processor 222 has more time to process the packet before arrival of the next packet, thus, the frequency could be lowered without falling behind wire-speed. Likewise, for a smaller packet, the frequency may be increased. Adaptively scaling the clock frequency “on the fly” for different incoming packets can reduce power by reducing operational frequency when processing larger packets. This can, in turn, result in a cooler running system that may avoid the creation of silicon “hot spots” and/or expensive cooling systems.

As shown in FIG. 15, scaling logic 224 receives packet data and correspondingly adjusts the frequency provided to the processing logic 210. While discussed above as operating on the packet size, a wide variety of other metrics may be used to adjust the frequency such as payload size, quality of service (e.g., a higher priority packet may receive a higher frequency), protocol type, and so forth. Additionally, instead of the characteristics of a single packet, aggregate characteristics may be used to adjust the clock rate (e.g., average size of packets received). To save additional power, the clock may be temporarily disabled when the network is idle.

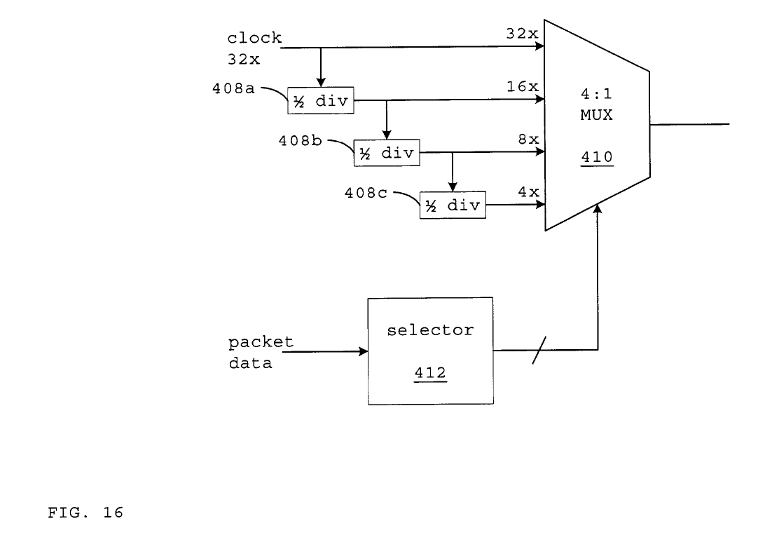

The scaling logic 224 may be implemented in wide variety of hardware and/or software schemes. For example, FIG. 16 depicts a hardware scheme that uses dividers 270a-270c to offer a range of available frequencies (e.g., 32×, 16×, 8×, and 4×). The different frequency signals are fed into a multiplexer 410 selection based on packet characteristics. For example, a selector 272 may feature a magnitude comparator that compares packet size to different pre-computed thresholds. For example, a comparator may use different frequencies for packets up to 64 bytes in size (32×), between 64 and 88 bytes (16×), between 88 and 126 bytes (8×), and 126 to 236 bytes (4×). These thresholds may be determined such that the processing logic clock frequency satisfies the following equation:

$$[ ( packet size / data \text{-} width ) * interface \text{-} clock \text{-} frequency ] >= ( interface \text{-} clock \text{-} cycles / interface \text{-} clock \text{-} frequency ) + ( maximum \text{-} number \text{-} of \text{-} instructions / processing \text{-} clock \text{-} frequency ) .$$

While FIG. 16 illustrates four different possible clock signals to output, other implementations may feature n-clocking signals. Additionally, the relationship between the different frequencies need not be uniformly fractional as shown in FIG. 16

The resulting clock signal can be routed to different components within the processing logic 210. Not all components within the processing logic 210 and interface 208 blocks need to run at the same clock frequency. For example, in FIG. 2, while the input sequencer 216 receives a “1×” clock signal and the processor 222 receives a “k×” clock signal”, the connection data memory 212 and CAM 214 may receive the “1×” or the “k×” clock signal, depending on the implementation.

Placing the scaling logic 224 physically near a frequency source can reduce power consumption. Further, adjusting the clock at a global clock distribution point both saves power and reduces logic need to provide power distribution.

Again, a wide variety of implementations may use one or more of the techniques described above. Additionally, the tracking scheme may appear in a variety of forms. For example, the tracking scheme may be included within a single chip, a chipset, or on a motherboard. Further, the technique may be integrated into other components such as a network adaptor, NIC (Network Interface Card), or MAC (medium access device). Potentially, the techniques described herein may integrated into a micro-processor.

Aspects of techniques described herein may be implemented using a wide variety of hardware and/or software configurations. For example, aspects of the techniques may be implemented in computer programs. Such programs may be stored on computer readable media and include instructions for programming a processor.

Other embodiments are within the scope of the following claims.

What is claimed is:

1. A method for use in tracking received out-of-order packets, the method comprising:
receiving at least a portion of a packet that includes data identifying an order within a sequence; and
based on the data identifying the order, requesting stored data identifying a set of contiguous previously received out-of-order packets having an ordering within the sequence that borders the received packet.

2. The method of claim 1, wherein the requesting stored data comprises requesting data from at least one content-addressable memory.

3. The method of claim 1, further comprising storing data that identifies, at least, the start and end boundaries of at least one of the sets.

4. The method of claim 3, wherein requesting the data comprises requesting data that identifies a set of contiguous previously received out-of-order packets that border the end of the received packet.

5. The method of claim 3, wherein requesting the data comprises requesting data that identifies a set of contiguous previously received out-of-order packets that border the start of the received packet.

6. The method of claim 1, further comprising,
if the received packet borders a set of contiguous previously received out-of-order packets, modifying the stored data for the set of contiguous previously received out-of-order packets to include the received packet.

7. The method of claim 1,
wherein the requesting data comprises querying at least two content-addressable memories, wherein a first of the content-addressable memories stores data that identifies the start of a boundary of at least one of the sets of contiguous previously received out-of-order packets and a second of the content-addressable memories stores data that identifies the end boundary of at least one of the set of contiguous previously received out-of-order packets; and
wherein the requesting data comprises:
querying the first content-addressable memory to determine if the received packet borders the start of a set of contiguous previously received out-of-order packets, and
querying the second content-addressable memory to determine if the received packet borders the end of a set of contiguous previously received out-of-order packets.

8. The method of claim 1, wherein the data identifying an order comprises at least one TCP (Transmission Control Protocol) sequence number.

9. The method of claim 8, wherein the stored data identifies the end of a set of contiguous previously received out-of-order packets, and wherein the end of a set is identified by incrementing the last sequence number of the last packet in the set by one.

10. The method of claim 1, wherein the received packet comprises a packet received in-order.

11. The method of claim 10, further comprising:
identifying a set of contiguous previously received out-of-order packets that border the end of the received in-order packet.

12. The method of claim 1, wherein the receiving the at least a portion of the packet comprises receiving data included in a header of the packet.

13. The method of claim 1, wherein the receiving the at least a portion of the packet comprises receiving the at least a portion at a network protocol off-load engine.

14. The method of claim 13, wherein the network protocol off-load engine comprises at least one content-addressable memory to store data for different network connections.

15. A computer program product, disposed on a computer readable medium, for use in tracking received out-of-order packets, the program including instructions for causing a processor to:
receive at least a portion of a packet that includes data identifying an order within a sequence; and
based on the data identifying the order, request stored data identifying at least one set of contiguous previously received out-of-order packets having an ordering within the sequence that borders the received packet.

16. The computer program of claim 15, wherein the instructions for causing the processor to request stored data comprise instructions for causing the processor to request data from at least one content-addressable memory.

17. The computer program of claim 15, further comprising instructions for causing the processor to store data that identifies, at least, the start and end boundaries of at least one of the sets of one or more previously received packets.

18. The computer program of claim 15, wherein instructions for causing the processor to request stored data comprise instructions for causing the processor to request stored data indicating that the received packet borders the start of a set of contiguous previously received out-of-order packets.

19. The computer program of claim 15, wherein instructions for causing the processor to request stored data comprise instructions for causing the processor to request stored data indicating that the received packet borders the end of a set of contiguous previously received out-of-order packets.

20. The computer program of claim 15, further comprising instructions for causing the processor to, if the received packet borders a set of contiguous previously received out-of-order packets, modify the stored data for the set of contiguous previously received out-of-order packets to include the received packet.

21. The computer program of claim 1,
wherein instructions for causing the processor to request data comprise instructions for causing the processor to access at least two content-addressable memories, wherein a first of the content-addressable memories stores data that identifies the start of a boundary of at least one of the sets of contiguous previously received out-of-order packets and a second of the content-addressable memories stores data that identifies the end boundary of at least one of the sets of contiguous previously received out-of-order packets; and
wherein the instructions for causing the processor to request data comprise instructions for causing the processor to:
query the first content-addressable memory to determine if the received packet borders the start of a set of contiguous previously received out-of-order packets, and
query the second content-addressable memory to determine if the received packet borders the end of a set of contiguous previously received out-of-order packets.

22. The computer program of claim 15, wherein the data identifying an order comprises at least one TCP (Transmission Control Protocol) sequence number.

23. The computer program of claim 22, wherein the stored data identifies the end of a set of contiguous previously received out-of-order packets, and wherein the end of a set is identified by incrementing the last sequence number of the last packet by one.

24. The computer program of claim 15, wherein the received packet comprises a packet received in-order and further comprising instructions for causing the processor to identify a set of contiguous previously received out-of-order packets that border the end of the received packet.

25. A system for tracking packet received out-of-order, the system comprising:
a memory to store data identifying at least one set of previously received out-of-order packets that are contiguous with respect to an ordering within a sequence; and
digital logic to request data from memory that identifies at least one set of contiguous previously received out-of-order packets having an ordering within the sequence that borders a received packet.

26. The system of claim 25, wherein the system comprises a system within a single chip.

27. The system of claim 25, wherein the memory comprises at least one content-addressable memory.

28. The system of claim 25, wherein the memory comprises a memory to store data identifying the start of the sets of contiguous previously received out-of-order packets and data identifying the end of the sets of contiguous previously received out-of-order packets.

29. The system of claim 25, wherein the digital logic to request data comprises digital logic to determine if the received packet borders the start of a set of contiguous previously received out-of-order packets.

30. The system of claim 25, wherein the digital logic to request data comprises digital logic to determine if the received packet borders the end of a set of contiguous previously received out-of-order packets.

31. The system of claim 25, further comprising,
digital logic to, if the received packet borders a set of contiguous previously received out-of-order packets, modify the stored data for the set of contiguous previously received out-of-order packets to include the received packet.

32. The system of claim 25, wherein the data identifying an order comprises at least one TCP (Transmission Control Protocol) sequence number.

33. The system of claim 25, further comprising digital logic to identify a set of contiguous previously received out-of-order packets that border the end of the received packet.

34. The system of claim 25, wherein the receiving the at least a portion of the packet comprises receiving a header of the packet.

35. The system of claim 25, wherein the receiving the at least a portion of the packet comprises receiving the at least a portion at a network protocol off-load engine.

36. A system, comprising:
at least one host processor;
an Ethernet medium access control (MAC) device to receive packets that include TCP (Transmission Control Protocol) segments over a network connection;
a TCP off-load engine that comprises:
a Peripheral Component Interface (PCI) bus interface to communicate with the at least one host processor;
at least one content-addressable memory to store data identifying sequence boundaries of sets of one or more contiguous, out-of-order TCP segments previously received via the Ethernet MAC device; and
digital logic to:
receive at least a portion a TCP header of a TCP segment received via the Ethernet MAC device; and
based on TCP sequence data included in the TCP header, query the at least one content-addressable memory for data identifying a set of contiguous previously received out-of-order segments having an ordering within the sequence that borders the received TCP segment.

37. The system of claim 36, wherein the digital logic further comprises logic to store data in the at least one content-addressable memory that identifies, at least, the start and end boundaries of at least one of the sets.

38. The system of claim 36, further comprising digital logic to:
if the received segment borders a set of one or more previously received segments, modify the content-addressable memory data for the set of one or more contiguous previously received segments to include the received segment.

39. The system of claim 36,
wherein the at least one content-addressable memories comprises at least two content-addressable memories,
wherein a first of the content-addressable memories stores data that identifies the start of a boundary of at least one of the sets of one or more contiguous previously received segments and a second of the content-addressable memories stores data that identifies the end boundary of at least one of the set of one or more contiguous previously received segments; and
wherein the digital logic to query the at least one content-addressable memory comprises digital logic to:
query the first content-addressable memory to determine if the received packet borders the start of a set, and
query the second content-addressable memory to determine if the received packet borders the end of a set.

40. The system of claim 36,
wherein the received segment comprises a segment received in-order; and
wherein the digital logic further comprises digital logic to query the content-addressable memory to identify a set of one or more contiguous previously received segments that border the end of the received segment.

41. The system of claim 36, wherein TCP off-load engine comprises a second set of at least one content-addressable memory to store data that identifies a TCB (Transmission Control Block) for different TCP connections.

42. The system of claim 36, wherein the TCP off-load engine comprises an engine having interface logic clocked at a first frequency and processing logic clocked at a second frequency.

43. The system of claim 42, wherein the digital logic changes the second frequency based on a header included in an Internet Protocol header of the received packet.
